(19) United States
(12) Patent Application Publication
(10) Pub. No.: US 2006/0116907 A1
(43) Pub. Date: Jun. 1, 2006

(54) System and method for improving performance of authorization for prescription drugs

(76) Inventors: Neal Alan Rhodes, Lilburn, GA (US); Patricia Lewis Rhodes, Lilburn, GA (US); April M. Harper, Auburn, AL (US); Guy R. DiBenedetto, Auburn, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/290,093

(22) Filed: Nov. 30, 2005

Related U.S. Application Data
(60) Provisional application No. 60/632,056, filed on Nov. 30, 2004.

(51) Int. Cl. G06Q 10/00

(52) U.S. Cl. 705/2

(57) ABSTRACT

A method is provided for utilizing a history database to process a prescription drug authorization request. One embodiment, among others, comprises the steps of: searching an authorization criteria database, producing authorization category records matching a drug identifier; for each of these records, adding a history record; receiving an authorization request; searching the criteria database, producing another set of authorization category records matching the category of the drug identifier; for each of these records, formulating a key comprising the request patient identifier and the matching authorization category; querying the history database using each formulated key, producing history records; and granting or denying the request based on applying the second set of authorization category records to the history records. The history record contains a composite key combining a portion of received claim information and at least a portion of the matching authorization category record.

### CROSS REFERENCE TO RELATED APPLICATIONS

This application claims the benefit of U.S. Provisional Application No. 60/632,056, filed Nov. 30, 2004.

### FIELD OF THE INVENTION

The present invention relates to insurance claim processing, and more specifically, to a system and method for improving performance of authorization for prescription drugs.

### BACKGROUND

The process of filling a drug prescription often involves a procedure (“authorization”) through which payment for the prescription is authorized by a third party payer (e.g., the patient's insurance company, or the state or federal government). This authorization procedure is often required by the payer for comparatively expensive drugs. The decision to authorize or approve a specific prescription for a specific patient is based on one or more criteria. Three commonly used criteria are Prior Therapy (i.e., “Has the patient tried multiple therapeutically similar but less expensive drugs in sufficient quantity in the recent past and found it was not effective?), Prior Diagnosis (i.e., “Has the patient been diagnosed with any condition/disease on this list in the past 180 days?”), and Stable Therapy (i.e., “Has the patient been taking the prescribed drug in sufficient quantities for the past 60 days?”).

Prior art solutions using a computer program for authorization are known. A pharmacist or pharmacist assistant provides the patient's identifier and a drug identifier to the program. The program looks up the patient's records in a prescription claim and diagnosis database, and compares these records with the criteria for this particular drug identifier. If the patient's history of claims and diagnoses meets the criteria, an electronic authorization is provided to the pharmacy. If not, an electronic rejection is provided, and manual intervention by the pharmacist or physician and/or a retry may be required.

Prior art solutions require a relatively long time (on the order of many seconds) to authorize or reject a prescription. One reason for this poor performance is the number of records in the claim/diagnosis database, which contains all prescriptions, even for drugs that aren't used in any criteria. Another factor is the size of each record. Claim records contain lots of information which isn't relevant to the criteria.

Yet another performance factor is the indexing scheme used. When a claim is presented, it is approved for a particular National Drug Code (NDC), which specifies a particular dosage, form, and package. A single “drug” such as Vioxx® is often available in different dosages, forms (capsule, tablet, etc.), and packages (30 tablet pack, 60 tablet packet, etc.), each with its own NDC. It is common for one “drug” to have dozens of NDCs, and some have hundreds.

Because claims are presented and approved for a particular NDC, prior art solutions typically index the claim database by NDC. However, applying the criteria “Has the patient taken an NSAID (Non-steroidal Anti-inflammatory) in the past 30 days” to a claim database indexed by NDC involves an inefficient query. Essentially, after a list of NSAID NDCs is created, the database must be searched sequentially for all records matching NDC₁, then all records matching NDC₂, then NDC₃, etc. The total number of NDCs which must be examined in this manner to authorize a particular drug can be hundreds or even thousands. Therefore, improvements to authorization for prescription drugs is desirable.

### SUMMARY

Systems and methods for utilizing a history database to process a prescription drug authorization request are provided. One embodiment, among others, comprises the steps of: searching an authorization criteria database, producing authorization category records matching a drug identifier; for each of these records, adding a history record; receiving an authorization request; searching the criteria database, producing another set of authorization category records matching the category of the drug identifier; for each of these records, formulating a key comprising the request patient identifier and the matching authorization category; querying the history database using each formulated key, producing history records; and granting or denying the request based on applying the second set of authorization category records to the history records. The history record contains a composite key combining a portion of received claim information and at least a portion of the matching authorization category record.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 is a logical view of an authorization criteria used by the system and method for improving performance of authorization for prescription drugs.

FIG. 2 is a high level data flow diagram of one embodiment of the system and method for improving performance of authorization for prescription drugs.

FIGS. 3A-C are data flow diagrams showing how the history database in FIG. 1 is populated.

FIGS. 4A-B are data flow diagrams showing how the history database in FIG. 1 is used to process a request for authorization.

FIG. 5 is a block diagram showing how one embodiment implements the authorization category 110 of FIG. 1.

FIG. 6 depicts the database tables and fields used by one embodiment of the system and method for improving performance of authorization for prescription drugs to implement the logical views of FIG. 1-3.

FIG. 7 is a flow chart showing how the prior use database of FIG. 2 is populated.

FIG. 8 is a flow chart showing how a request for prior authorization is processed.

FIG. 9 is a block diagram of a system implementing the method for improving performance of authorization for prescription drugs.

### DETAILED DESCRIPTION

The system and method for improving performance of authorization for prescription drugs uses a novel technique which pre-processes claims and diagnoses before authorization. The pre-processing is done off-line, that is, not during the real-time authorization process. Typically, the pre-processing is done in conjunction with adding claims and diagnoses to a claims/diagnosis database. Since the threshold values for criteria (e.g., How Many days Prior, How Many Days Supply) can be altered by the payer at any time, the authorization decision is not made during pre-processing. However, the pre-processing isolates relevant data, producing a smaller prior-use database for use in the real-time authorization process. Importantly, the prior-use database is indexed by criteria rather than by NDC. Thus, when the criteria is applied during the authorization process, an efficient query can be constructed and the search time is greatly reduced.

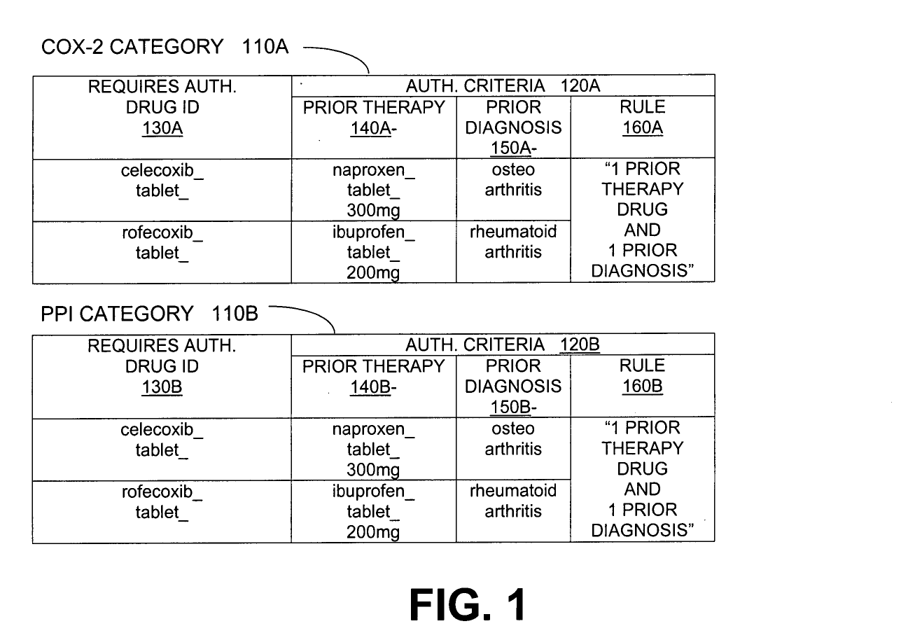

FIG. 1 is a logical view of an authorization criteria used by the system and method for improving performance of authorization for prescription drugs. When filling a prescription for certain drugs, authorization is required by the third party payer. Drugs that have the same authorization criteria are grouped into authorization categories 110. An authorization category 110 contains the criteria for authorization (120) and the drugs requiring this criteria (130). The criteria 120 may include a list of drugs required as prior therapy (140), a list of required diagnoses (150), and a rule which describes the criteria in terms of the two lists (160).

FIG. 1 shows two example authorization categories 110A and 110B. Category 110A describes the criteria (120A) required before authorizing drugs from the list 130A, which includes celecoxib and rofecoxib. The rule is 2 drugs from the list 140A, which includes ibuprofen and naproxen, and 1 diagnosis from the list 150A, which includes osteoarthritis and rheumatoid arthritis. Category 110B describes the criteria (120B) required before authorizing drugs from the list 130B, which includes omeprazole. The rule is 1 drug from the list 140B, which includes ranitidine and cimetidine.

Throughout this description, descriptive strings are used for the patient identifier and the drug identifier. In a preferred embodiment, the patient identifier is an identification number (e.g., medical identification number, social security number, etc.), the drug identifier is an NDC, and the diagnosis identifier is an ICD-9 (International Classification of Diseases) code.

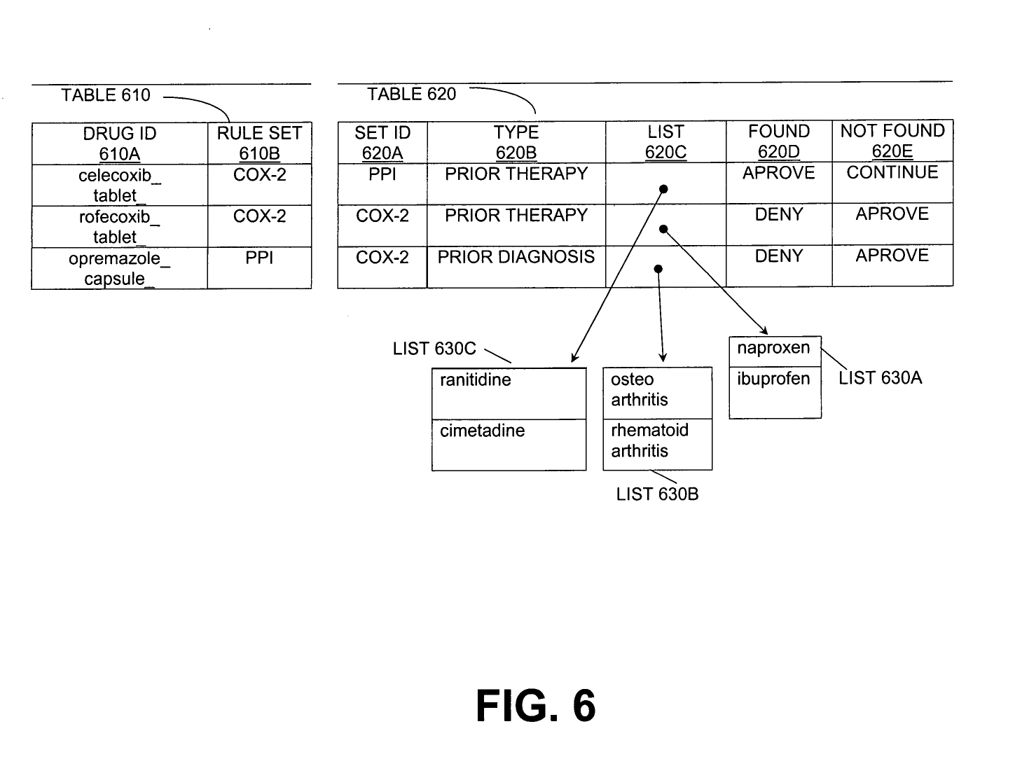

A person of ordinary skill in the art of database design will understand that FIG. 1 represents a logical view of data and relationships, and that the criteria database of a particular embodiment may use tables and fields in various combinations to achieve this logical view. Specific tables and fields used by an example embodiment of a criteria database will be discussed later in connection with FIG. 6.

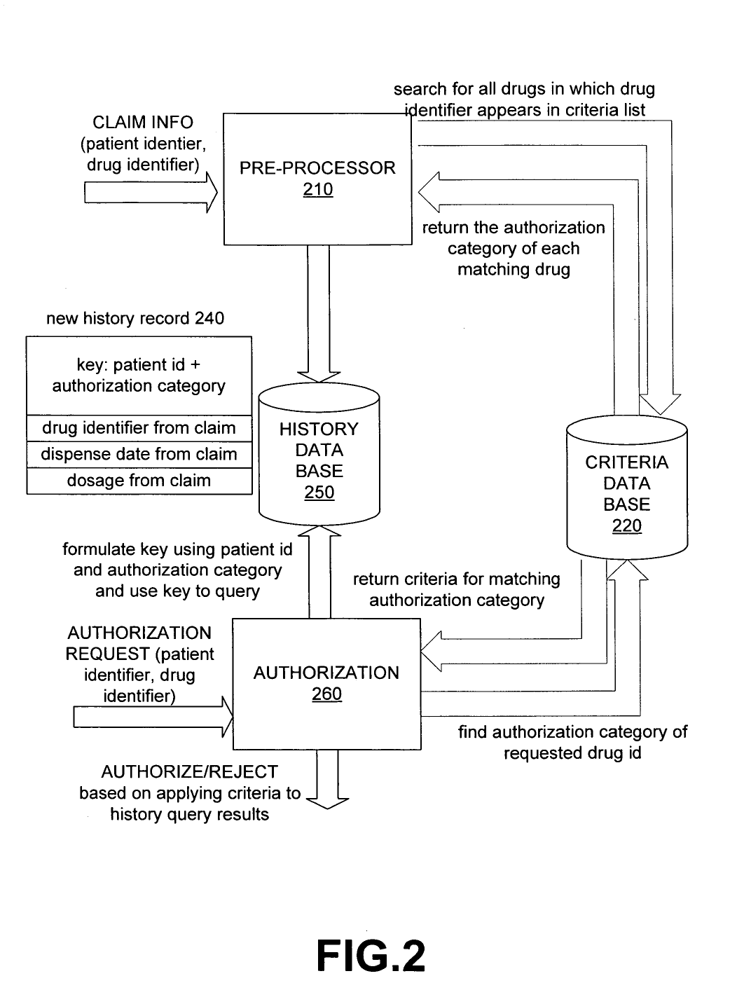

FIG. 2 is a high level data flow diagram of one embodiment of the system and method for improving performance of authorization for prescription drugs. Since authorizing a particular drug may require a different drug be prescribed first, a preprocessor component 210 tracks the history of insurance claims for a particular patient and drug 215. When a claim for a drug 215 is received, the preprocessor 210 determines if this drug 215 is relevant to the authorization of any other drug, by examining the authorization categories 110 in an authorization criteria database 220.

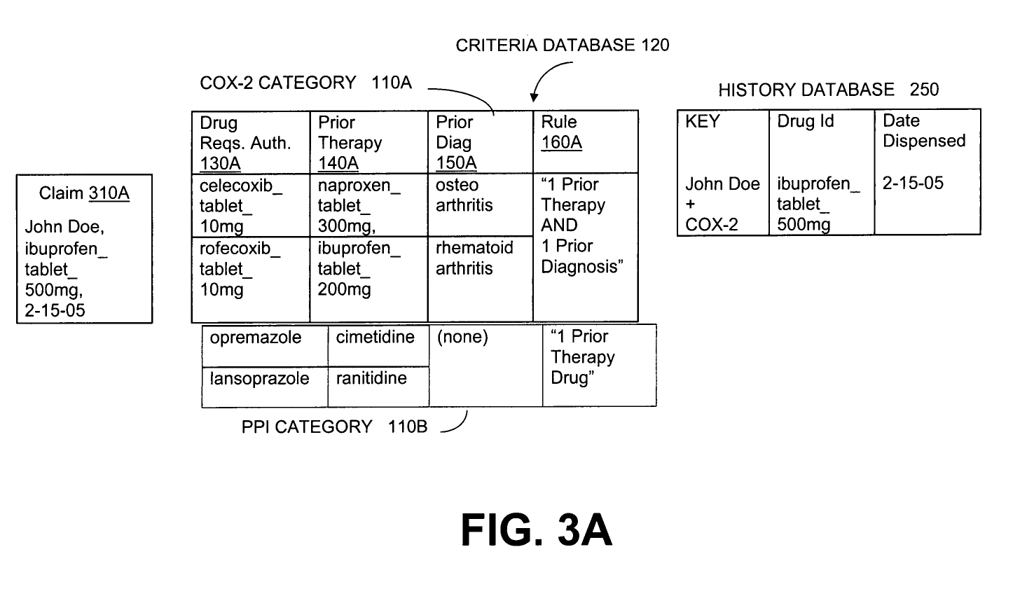

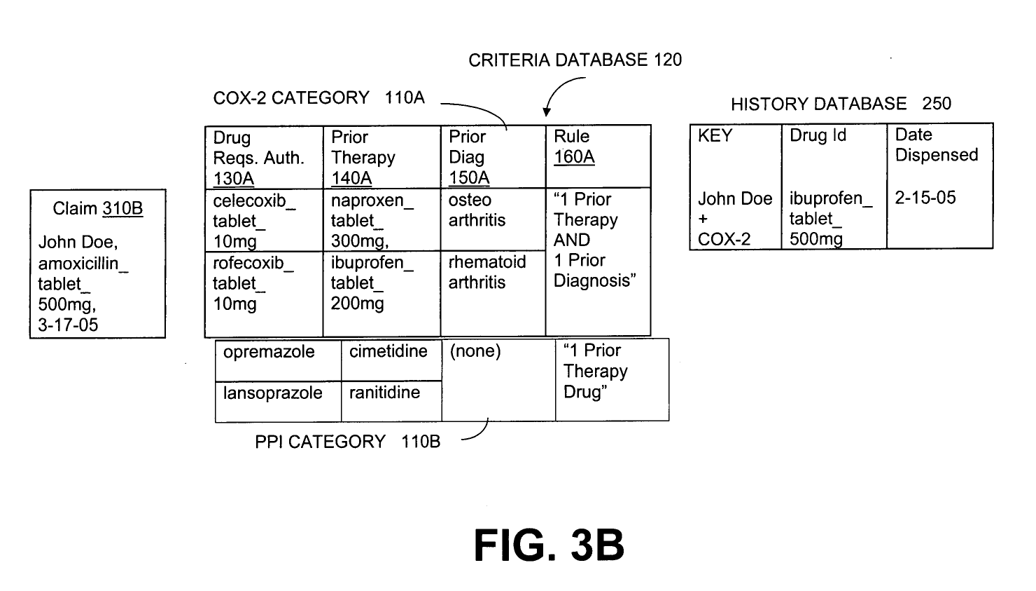

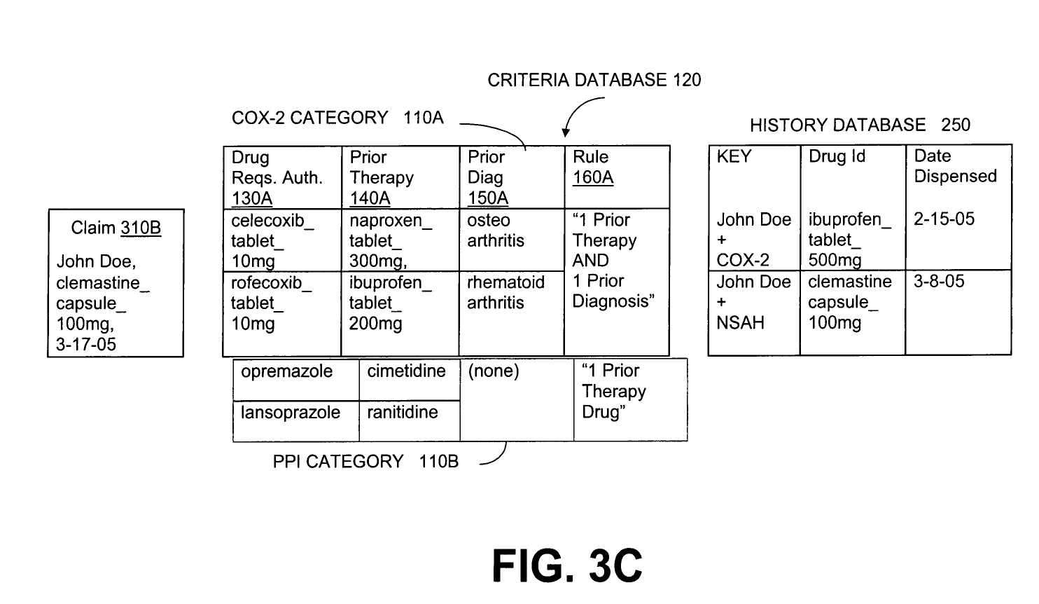

If the received drug 215 is found in a prior therapy list 140, then the preprocessor 210 creates a history record 240 and adds this record 240 to a history database 250. Importantly, one of the fields of the history database 250 is a composite key, formed by combining fields in the received claim information and the matching authorization category 110. (The fields in history database 250 and the composite key will be discussed in more detail later in connection with FIGS. 3A-C.)

This process is repeated as additional prescription drug claims 215 are received by the preprocessor 210. As described earlier, diagnoses may also be used as authorization criteria. Therefore, in addition to processing prescription drug claims 215, the preprocessor 210 may also search in for diagnoses in a diagnosis list 150, and create a history record 240 in a similar manner.

Periodically, an index for the history database 250 is created using the composite key. A person of ordinary skill in the art of insurance claims processing will understand that the pre-processing can be done as part of the procedure that adds new claims to a claims database, or can be done as a separate procedure.

An authorization component 260 receives a authorization request 270 for an identified patient and drug. The authorization component 260 searches the authorization criteria database 220 for the authorization category 110 with a drug-for-authorization 130 which matches the drug identifier in the request. If there are no matching authorization categories 140, then no criteria are required, and the authorization request is granted.

If a matching authorization category 110 is required, then the authorization component 260 determines whether the history of the requesting patient, contained in history database 240, meets the criteria 120 in the matching authorization category 110. Importantly, the authorization component 260 is able to make this determination efficiently by formulating a key which combines fields in the received request 270 and the matching criteria 120.

The authorization component 260 performs a query on the history database 250 using this key. (The query is efficient because the history database 250 is indexed by this composite key.) The query produces a set of history records 240 representing drugs which have already been dispensed to the requesting patient, or diagnoses made of the patient, where these drugs are also criteria for determining whether or not the requested drug will be authorized.

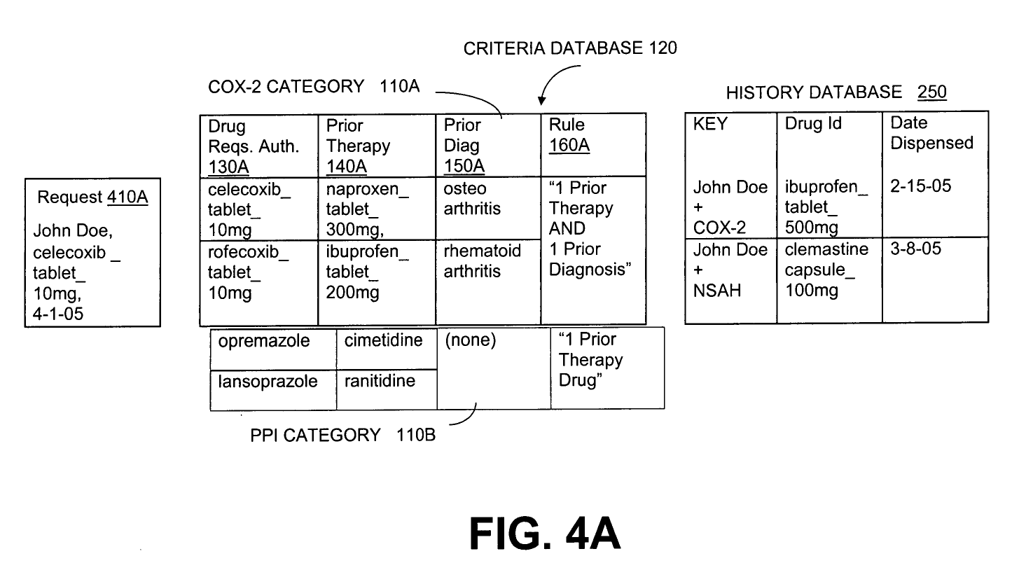

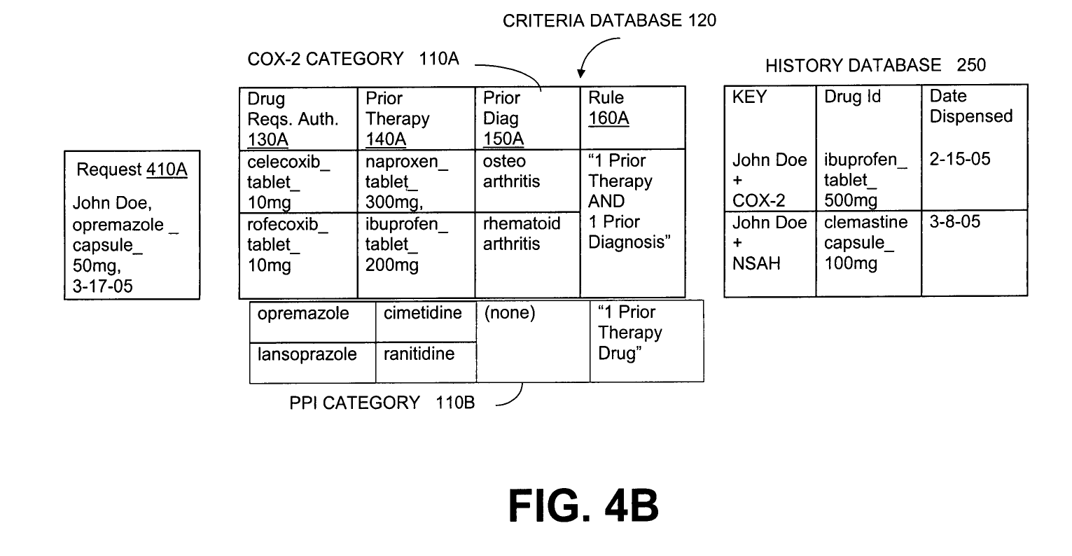

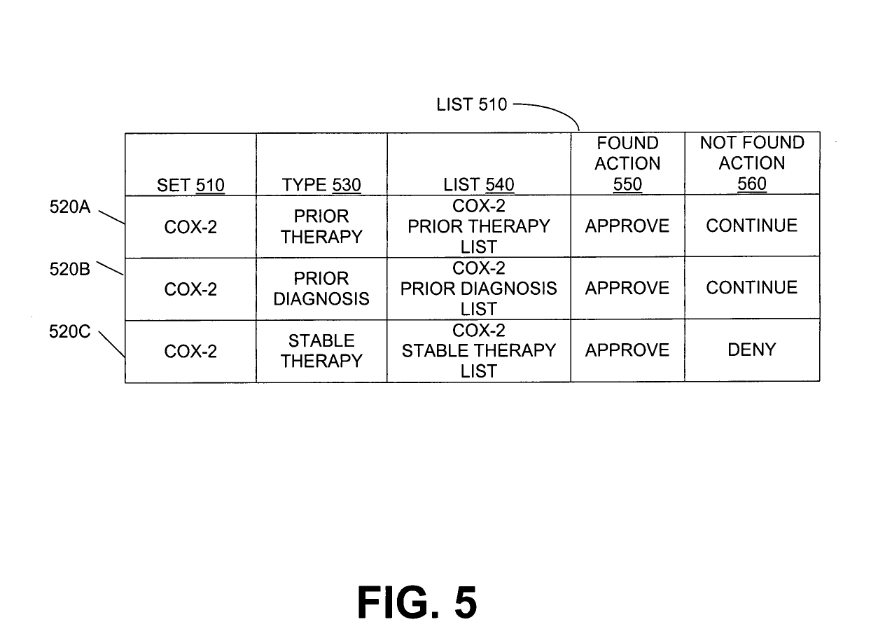

If the set of history records 240 is not empty, further comparisons are made between the history records 240 and the criteria 120 in the matching authorization category 110. Based on these comparisons (discussed in more detail in connection with FIG. 4), the authorization request is granted or denied. If the set of history records 240 is empty, then the criteria 120 in the matching authorization category 110 is examined further (as discussed in more detail in connection with FIG. 5) to determine whether the authorization request is granted or denied.

Although illustrated as separate components, a person of ordinary skill in the art of insurance claims processing will understand that the functionality provided by the authorization component 260 and the preprocessor 210 may be partitioned a variety of ways.

FIGS. 3A-C are data flow diagrams showing how the history database 150 is populated by using the authorization criteria database 120 to pre-process a set of claims. In FIG. 3A, the authorization criteria database 120 contains 3 authorization categories 110A-C, and history database 150 is initially empty. Claim 310A is received for patient “John Doe”. Claim 310A specifies that a prescription for “ibuprofen_tablet_{—}500 mg” was filled on “Feb. 15, 2005”.

On receipt of the claim 310A, the preprocessor 110 determines if the drug in claim 310A is relevant to the authorization of any other drug, by searching the authorization categories 140 in the authorization criteria database 120 to find matches on the drug identifier in claim 310A. More specifically, the preprocessor 110 searches for any authorization categories 140 with a prior therapy list 140 that include the drug identifier in claim 310A. The preprocessor 110 creates a new history record using information in the received claim 310A and information in the category 110 of the matching prior therapy list 140.

The history record 140 is initialized as follows. The Drug_Identifier field 150B and Dispensation_Date field 150C are initialized according to corresponding fields in the received claim information 310. The Key field 150A is formed by combining the Patient_Identifier field in the received claim information 310 with the authorization category 110 of the matching prior therapy list 140. Importantly, the history record 140 does not generally contain all information in the claim record 310.

In the example of FIG. 3A, the authorization criteria database 120 contains one prior therapy list (140A) that includes the received drug identifier (“ibuprofen_tablet_{—}500 mg”). The authorization category for the matching prior therapy list (140A) is “COX-2”. Thus, the composite key field 150A in the new history record 140A is set to “John Doe+COX-2.” Since the received drug identifier was only found in one prior therapy list (140A), only one history record (140A) is added to the history database 150. However, in a case where more than one prior therapy list 140 matches, additional history records 140 are created, one for each match. The preprocessor 110 is then ready to process another claim.

Turning to FIG. 3B, claim 310B is received for patient “John Doe”. Claim 310B specifies that a prescription for “Amoxicillin_tablet_{—}500 mg” was filled on “Mar. 17, 2005”. On receipt of the claim 310B the preprocessor 110 searches the authorization categories 140 in the authorization criteria database 120 to find matches on the drug identifier “amoxicilin_tablet_{—}500 mg”. In the example of FIG. 2B, there are no prior therapy lists 140 that matching this drug identifier, so the preprocessor 110 does not create another history record 140, and the history database 150 still contains one record.

Turning to FIG. 3C, claim 310C is received for patient “John Doe”. Claim 310C specifies that a prescription for “clemastine_capsule_{—}350 mg” was filled on “Mar. 8, 2005”. On receipt of the claim 310C, the preprocessor 110 searches the authorization categories 110 in the authorization criteria database 120 to find matches on the drug identifier in the claim 310C.

In the example of FIG. 3C, one authorization category (110C) has a prior therapy list (140C) matching the drug identifier “clemastine_capsule_{—}350 mg”. The preprocessor 110 uses information in the received claim 310C and the matching authorization category 110C to create a new history record 140B. The Key field 150A of history record 140B is set to “John Doe+NSAH”. The remaining fields in history record 140B are initialized from information in received claim 310C, as described earlier.

FIGS. 4A-B are data flow diagrams showing how the history database 150 is used to process a request for authorization. An authorization request (410A, 410B) containing a Patient_Identifier, a Drug_Identifier, and a Date, is received by the authorization component 160. The authorization component 160 searches the authorization criteria database 120 for a drug-for-authorization list 130 that includes the drug identifier in the request. If no drug-for-authorization list 130 matches, then no authorization is required, and the authorization component 160 grants the request 410. If a match on the drug-for-authorization list 130 is found, then the authorization category 110 with the matching list also contains criteria which must be met in order to authorize a prescription for the requested drug.

In the example of FIG. 4A, the request 410A contains Patient_Identifier “John Doe” and Drug_Identifier “celecoxib_tablet_{—}10 mg.” The drug-for-authorization list 130A includes this drug identifier, and list 130 is found in authorization category 110A. The authorization component 160 therefore forms a key using the Patient_Identifier “John Doe” from the request 410A, the name of the authorization category 110A, “COX-2.”

The authorization component 160 queries the history database 150 with this key (“John Doe+COX-2”). This type of query is efficient because the history database 150 is indexed by this composite key. In this example, the query of the history database 150 produces a result set containing one record (140A). This result set represents drugs which have already been dispensed to the requesting patient, and which are also criteria for determining whether or not the requested drug will be authorized.

The authorization component 160 then applies the criteria 120 in the matching authorization category 110 to the drugs in the history result set 140. In this particular example, the history record 140A indicates “ibuprofen dispensed on Feb. 15, 2005”. This meets the rule 160A “1 drug from NSAID list”, since prior therapy list 140A contains ibuprofen. Therefore, request 410A is authorized. If the rule 160 requires more than one drug as prior therapy, then the authorization component 160 looks for additional matches in the history result set 140.

Turning to FIG. 4B, another request 410B is received by the authorization component 160. The request 410B is for Patient Identifier “John Doe” and Drug_Identifier “opremazole_capsule 50 mg.” The authorization component 160 searches the authorization criteria database 120 to find any drug-for-authorization lists 130 that includes the Drug_Identifier in the request 410B (“opremazole_capsule_{—}50 mg”). In this example, one drug-for-authorization list (130C) includes “opremazole_capsule_{—}50 mg”, and this list 130C is part of authorization category 110C.

The authorization component 160 formulates a key using the Patient_Identifier “John Doe” from the request 410B and the matching authorization category 110C. The authorization component 160 queries the history database 150 with this key (“John Doe+PPI Prior Therapy”).

In this example, the query returns the empty set: this patient has no prior usage of any PPI Prior Therapy drug. However, in some cases an authorization criteria calls for the absence of Therefore, the specific criteria 120 for this matching authorization category (110C) are then processed to determine whether Request 410B is granted or denied. The details of processing rules 150 in criteria 120 to make this determination will now be discussed.

FIG. 5 is a block diagram showing how one embodiment implements the authorization category 110 of FIG. 1. In FIG. 1, a rule 150 for a particular category 110 is associated with a list of prior therapy drugs (140) and a list of diagnoses (150). The embodiment of FIG. 5 represents the data and relationships of a category 110 in a different way.

In the embodiment of FIG. 5, an authorization category 110 is implemented as a list (510) of rules (520A-C). Each individual rule 520 has a type (530) and a therapy/diagnosis list (540). In this embodiment, the type field 530 can have the value “Prior Therapy”, “Required Diagnosis” or “Stable Therapy”. Other embodiments may also include the values “Contraindicated Therapy” and “Contraindicated Diagnosis.” A person of ordinary skill in the art will recognize that these rule types are merely examples, and that other rule types may be used.

Each rule 520 also has a Found action (550), and a Not Found action (560). In this embodiment, the action fields can have the value “Manual”, “Refuse”, “Deny”, “Approve”, “Continue” or “Follow-up”.

This data representation allows complex interactions between rules in a list 510 to be expressed. The example of FIG. 5 uses the value “Approve” for the Found Action 550 in both the “Prior Therapy” rule (510A) and the “Required Diagnosis” rule (510B). This set of values represents an OR condition: approval is given is either rule is met. An AND condition is represented by using “Continue” in the Found Action 550 of a first rule and “Approve” in the Found Action 550 of a second rule, with “Deny” in the Not Found Action 560 of both rules.

As another example, a contraindication can be represented by using “Deny” in the Found Action 550 of a rule (e.g., deny authorization of Paxil® if patient history contains warfarin). As a final example, an override rule can be expressed by using “Refuse” in the Found Action 550.

FIG. 6 depicts the database tables and fields used by one embodiment of the system and method for improving performance of authorization for prescription drugs to implement the logical views of FIG. 1-3. Drugs Requiring_Authorization table 610 maps a drug identifier 610A to a particular set of rules in criteria table 620. More than one drug identifier 610A can map to the same rule set. In the example of FIG. 5, both celecoxib and rofecoxib map to the same “COX-2” rule set in criteria table 620.

Criteria table 620 has fields Set identifier 620A, Type 620B, List 620C, Found Action 620D and Not Found Action 620E. Rules in table 620 with the same Set Identifier 620A belong to the same rule set. In the example of FIG. 5, the first two rules, with Type 620B “Prior Therapy” and “Required Diagnosis” belong to the same set (“COX-2”).

Each list 630 groups a set of drug identifiers into an authorization category (110). Each list 630 is referenced by criteria table 620. A particular list 630 can be referenced in more than one rule in the same rule set of table 620, and can also be reference by more than one rule set in table 620.

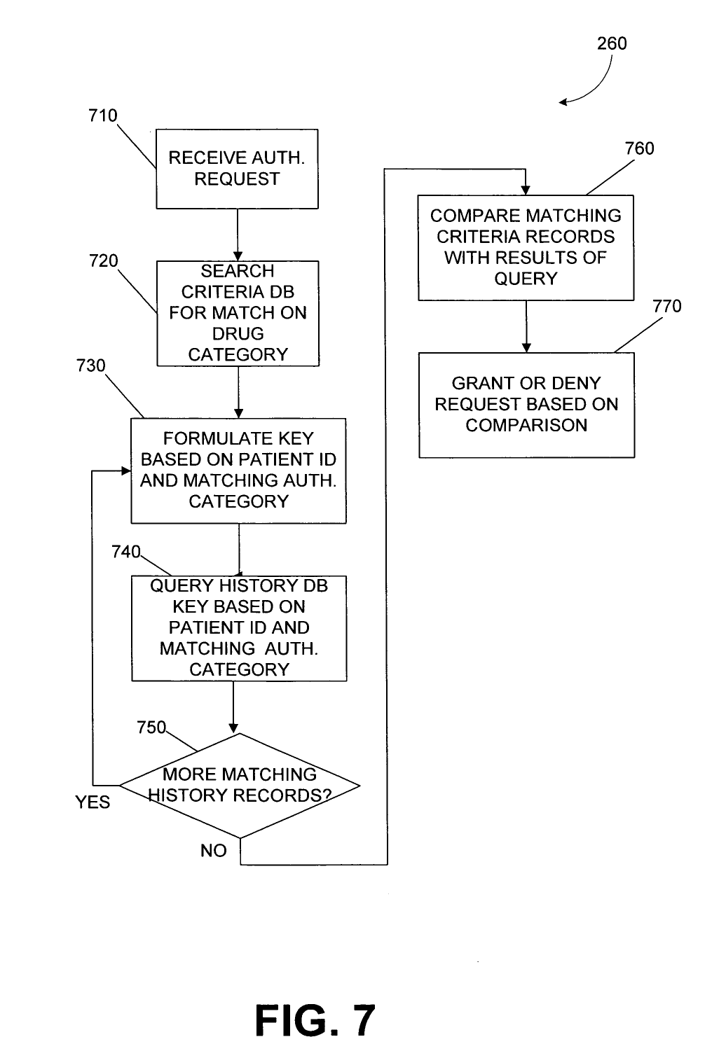

FIG. 7 is a flow chart of one embodiment of the preprocessor 110 described earlier. At block 710, claim information is received, including a patient identifier and a drug or diagnosis identifier. Processing continues at block 720, where the authorization criteria database 120 is searched to produce a first set of authorization category records matching the received drug identifier.

At block 730, a new record is added to the history database 150. The new record is initialized based on the received information and one of the authorization category records in the first set. Step 740 determines whether authorization category records in the first set remain to be processed. If Yes, then the next criteria record in the first set is processed at block 730. If No, the first set has been processed, and processing returns to block 710, where another claim is received.

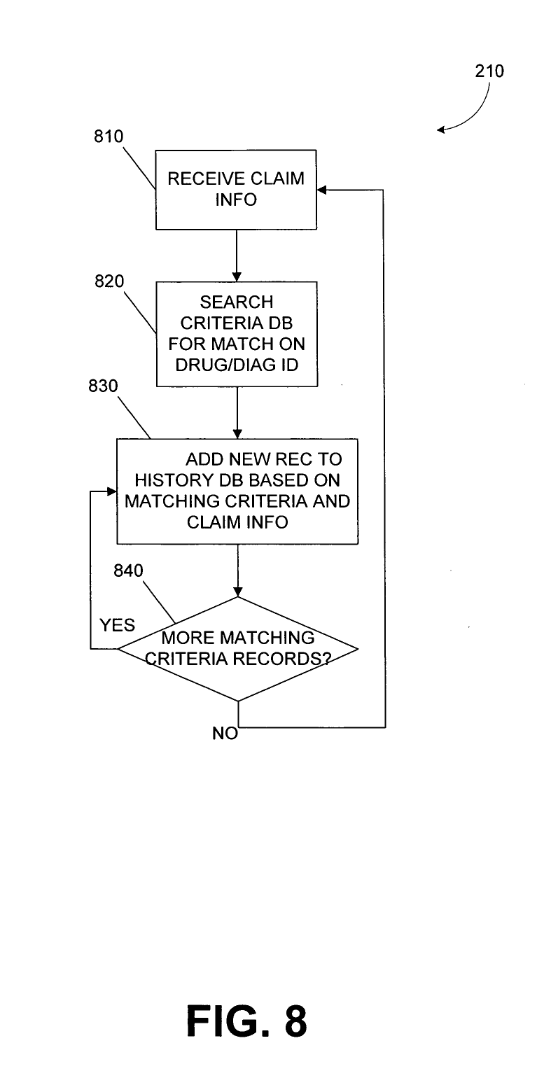

FIG. 8 is a flow chart of the authorization component 160 described earlier. At block 810, a request for authorization is received, including a patient identifier and a drug/diagnosis identifier. Processing continues at block 820, where the authorization criteria database 120 is searched for an authorization category matching the received drug/diagnosis identifier.

Next, block 830 formulates a composite key based on the patient identifier in the received request and the matching authorization category. This composite key is then used at block 840 to query the history database 150, producing a result set of history records. Block 850 determines whether or not matching authorization category records remain to be processed. If Yes, then processing continues at block 830, where another key is formulated using the next matching authorization category record. If No, then the composite key queries are complete and processing continues at block 860.

Block 860 compares the result set of history records (produced at block 840) with the matching authorization category records (produced at block 820). Next, block 870 decides whether or not to grant the request (received in block 810), based on the comparison in block 860. (The comparison and grant/deny decision were discussed earlier in connection with FIGS. 4A-B and 5.)

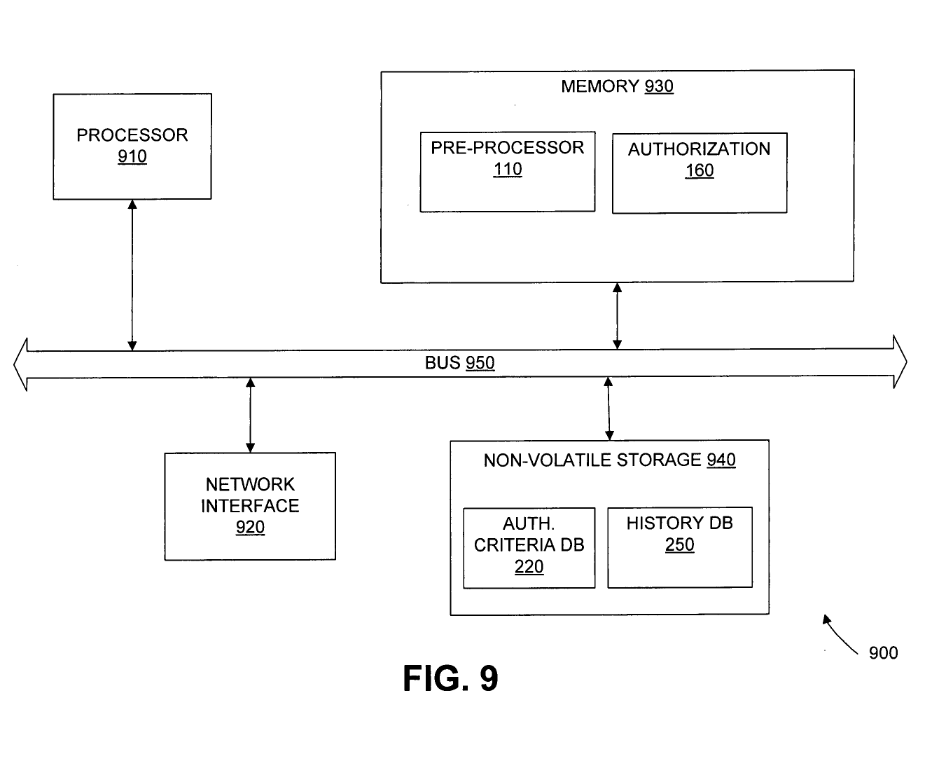

FIG. 9 is a hardware block diagram of an example embodiment of the system and method for improving performance of authorization for prescription drugs. The system 900 includes a number of components that are well known in the art of database computing, including a processor 910, a network interface 920, memory 930, and non-volatile storage 940. Examples of non-volatile storage include, for example, a hard disk, flash RAM, flash ROM, EEPROM, etc. These components are coupled via a bus 950.

The system 900 is in communication with other computer devices through the network interface 920. Memory 930 contains the preprocessor 110 and authorization 160 components described earlier, which execute on the processor 910. Storage 940 contains the authorization criteria database 220 and history database 250 described earlier.

Omitted from FIG. 9 are a number of conventional components, known to those skilled in the art, that are not necessary to explain the operation of the system and method for improving performance of authorization for prescription drugs. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

What I claim is:

1. A method for utilizing a history database to process a prescription drug authorization request, the method comprising the steps of:
searching an authorization criteria database to produce a first set of authorization category records matching a received drug identifier;
for each category in the first set, adding a history record to the history database, the history record containing a composite key field which combines a portion of the received claim information and at least a portion of the matching authorization category record;
receiving a authorization request comprising a patient identifier and a drug identifier;
searching the authorization criteria database to produce a second set of authorization category records having a category field matching a drug category associated with the received drug identifier;
for each authorization category record in the second set, formulating a key comprising the patient identifier in the authorization request and the authorization category;
querying the history database using each formulated key to produce a set of history records; and
determining if the authorization request is granted or denied based on applying criteria in the second set of authorization category records to the set of history records.

2. The method of claim 1, wherein the determining step further comprises:
granting the authorization request if a dispense date of one of the history records is contained within a time window defined by a date in the authorization request and a period in a corresponding one of the second set of authorization category records.

3. The method of claim 1, wherein the determining step further comprises:
comparing one or more fields in one of the history records with one or more fields in one of the second set of authorization category records; and
granting the authorization request based on the comparison.

4. The method of claim 1, wherein the determining step further comprises:
granting the authorization request if a number field of one of the authorization category records is at least as large as the number of records in the set of history records.

5. The method of claim 1, wherein the step of determining step further comprises:
granting the authorization request if no drug category is associated with the received drug identifier.

6. The method of claim 1, wherein the step of determining step further comprises:
granting the authorization request if the second set of authorization category records is empty.

7. The method of claim 1, further comprising the step of:
building an index for the history database using the composite key.

8. The method of claim 1, further comprising the step of:
determining the authorization category associated with the received drug identifier in the authorization request.

9. The method of claim 1, further comprising the step of:
receiving prescription drug claim information comprising the patient identifier and the drug identifier.

10. A system for utilizing a history database to process a prescription drug authorization request, the system comprising the steps of:
means for searching an authorization criteria database to produce a first set of authorization category records matching a received drug identifier;
means adding a history record to the history database for each category in the first set, the history record containing a composite key field which combines a portion of the received claim information and at least a portion of the matching authorization category record;
means for receiving a authorization request comprising a patient identifier and a drug identifier;
means for searching the authorization criteria database to produce a second set of authorization category records having a category field matching a drug category associated with the received drug identifier;
means for formulating a key for each authorization category record in the second set, the key comprising the patient identifier in the authorization request and the authorization category;
means for querying the history database using each formulated key to produce a set of history records; and
means for determining if the authorization request is granted or denied based on applying criteria in the second set of authorization category records to the set of history records.

11. The system of claim 10, wherein the means for determining further comprises:
means for comparing one or more fields in one of the history records with one or more fields in one of the second set of authorization category records; and
means for granting the authorization request based on the comparison.

12. The system of claim 10, wherein the means for determining further comprises:
means for granting the authorization request if a dispense date of one of the history records is contained within a time window defined by a date in the authorization request and a period in a corresponding one of the second set of authorization category records.

13. The system of claim 10, wherein the means for determining further comprises:
means for granting the authorization request if no drug category is associated with the received drug identifier.

14. The system of claim 10, wherein the means for determining further comprises:
means for granting the authorization request if the second set of authorization category records is empty.

15. A computer readable medium having a program for utilizing a history database to process a prescription drug authorization request, the program comprising logic for performing the steps of:
searching an authorization criteria database to produce a first set of authorization category records matching a received drug identifier;
for each category in the first set, adding a history record to the history database, the history record containing a composite key field which combines a portion of the received claim information and at least a portion of the matching authorization category record;
receiving a authorization request comprising a patient identifier and a drug identifier;
searching the authorization criteria database to produce a second set of authorization category records having a category field matching a drug category associated with the received drug identifier;
for each authorization category record in the second set, formulating a key comprising the patient identifier in the authorization request and the authorization category;
querying the history database using each formulated key to produce a set of history records; and
determining if the authorization request is granted or denied based on applying criteria in the second set of authorization category records to the set of history records.

16. The computer readable medium of claim 15, wherein the determining step further comprises:
comparing one or more fields in one of the history records with one or more fields in one of the second set of authorization category records; and
granting the authorization request based on the comparison.

17. The computer readable medium of claim 15, wherein the determining step further comprises:
granting the authorization request if a dispense date of one of the history records is contained within a time window defined by a date in the authorization request and a period in a corresponding one of the second set of authorization category records.

18. The computer readable medium of claim 15, wherein the determining step further comprises:
means for granting the authorization request if no drug category is associated with the received drug identifier.

19. The computer readable medium of claim 15, further comprising the step of:
building an index for the history database using the composite key.

20. The computer readable medium of claim 15, further comprising the step of:
determining the authorization category associated with the received drug identifier in the authorization request.
